(19) United States
(12) Patent Application Publication
(10) Pub. No.: US 2023/0248201 A1
(43) Pub. Date: Aug. 10, 2023

(54) SYSTEMS AND METHODS FOR ENGAGING BRAKES ON A ROBOTIC DEVICE

(71) Applicant: Brain Corporation, San Diego, CA (US)

(72) Inventor: Jeremiah Cox, San Diego, CA (US)

(21) Appl. No.: 18/095,778

(22) Filed: Jan. 11, 2023

Related U.S. Application Data
(63) Continuation of application No. PCT/US21/41484, filed on Jul. 13, 2021.
(60) Provisional application No. 63/050,986, filed on Jul. 13, 2020.

(51) Int. Cl. A47L 11/24; A47L 11/40

(52) U.S. Cl. CPC A47L 11/24; A47L 11/4066; A47L 11/4075; A47L 2201/04; B25J 5/007

(57) ABSTRACT

Systems and methods for engaging brakes on a robotic device are disclosed herein. According to exemplary embodiments, a user-controlled input device of the robotic device may configure a braking system to engage or disengage based on the user-controlled input device being engaged or disengaged by a user and the robotic device receiving a certain threshold of power. The user-controlled input device being engaged enables a human operator to move the robotic device.

### PRIORITY

This application is a continuation of International Patent Application No. PCT/US21/41484 filed on Jul. 13, 2021 and claims the benefit of U.S. Provisional Patent Application Ser. No. 63/050,986 filed on Jul. 13, 2020 under 35 U.S.C. § 119, the entire disclosure of each is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

The present application relates generally to robotics, and more specifically to systems and methods for configuring brakes on a robotic device.

Currently, some robots may operate both under user control and autonomously. Typically, the user control is provided for (i) training a robot to learn and execute a route or task, (ii) moving the robot into or out of storage, or (iii) moving the robot away from difficult situations where it may or has become stuck. Typically, robots may comprise wheels, treads, or other locomotion means, each comprising a braking system configured to stop or slow the robot. It is desirable to configure the braking systems to accommodate both the user control and enhance safety for the robot, nearby humans, and nearby objects. Some robots may be required to switch between autonomous operation and user-guided operation quickly, wherein the user further providing input to engage or disengage braking systems may be tedious and time-consuming to robot operators. Accordingly, there is a need in the art for a robotic braking system that is configurable to receive user control, automatically engage in potentially unsafe situations, and reduce the need for user input to operate robots.

The foregoing needs are satisfied by the present disclosure, which provides for, inter alia, systems and methods for configuring brakes on a robotic device.

Exemplary embodiments described herein have innovative features, no single one of which is indispensable or solely responsible for their desirable attributes. Without limiting the scope of the claims, some of the advantageous features will now be summarized. One skilled in the art would appreciate that, as used herein, the term robot may generally refer to autonomous vehicle or object that travels a route, executes a task, or otherwise moves automatically upon executing or processing computer-readable instructions.

According to at least one non-limiting exemplary embodiment, a robotic system is disclosed. The robotic system, comprising: a user-controlled input comprising at least an engaged state and a disengaged state; actuator units configured for locomotion of the robotic system, the actuator units being coupled to a brake, the brake configured to inhibit locomotion of the robotic system when engaged; a power supply; and at least one processing device configured to execute computer readable instructions stored on a memory to, engage the brake upon the power supply outputting a power level below a threshold and the user-controlled input being in the disengaged state; release the brake upon the user-controlled input being in the engaged state; and control navigation of the robotic system along a route and avoid obstacles upon the user-controlled input being in the disengaged state and the power supply outputting above a threshold power level.

According to at least one non-limiting exemplary embodiment, a respective state of the user-controlled input is detected in either the engaged state or the disengaged state based on output of an electromechanical switch.

According to at least one non-limiting exemplary embodiment, the user-controlled input is configured to receive a user guidance to move the robotic system along a route. According to at least one non-limiting exemplary embodiment, the user-controlled input comprises a handle configured to be extended from the robotic system and retracted into the robotic system, wherein in the extended configuration the handle is configured to be engaged by a user, and in the retracted configuration the handle is configured to be in the disengaged state; and the user guidance comprises one of pushing or pulling the handle.

According to at least one non-limiting exemplary embodiment, the robotic system comprises a floor cleaning robot.

According to at least one non-limiting exemplary embodiment, the robotic system further comprises: a user interface configurable to receive a user input, the user input configured to autonomously operate the robotic system when the user-controlled input is in the disengaged state.

According to at least one non-limiting exemplary embodiment, the control of the navigation of the robotic system further comprises receipt of the user input to begin autonomous operation of the robotic system.

According to at least one non-limiting exemplary embodiment, the user-controlled input comprises one of a retractable handle, a joystick, a throttle knob, or a steering wheel.

According to at least one non-limiting exemplary embodiment, a robotic system is disclosed. The robotic system, comprising: a user-controlled input comprising at least an engaged state and a disengaged state; actuator units configured for locomotion of the robotic system, the actuators being coupled to a brake, the brake inhibits the locomotion when engaged; a power supply; and at least one processing device configurable to execute computer readable instructions stored on a memory to, engage a brake upon the power supply outputting a power level below a threshold and the user-controlled input being in the disengaged state; release the brake upon the user-controlled input being in the engaged state; control navigation of the robotic system along a route and avoid obstacles upon the user-controlled input being in the disengaged state and the power supply outputting above a threshold power level; and receive a user input from a user interface configurable to, in part, the user input configures the robotic system to operate autonomously when the user-controlled input is disengaged; wherein, a respective state of the user-controlled input is detected in either the engaged state or disengaged state based on output of an electromechanical switch; the user-controlled input is configurable to receive a user guidance to move the robotic system; the user-controlled input comprises a handle configured to be extended from the robotic system and retracted into the robotic system, the extended configuration the handle is configured to be engaged by a user, and in the retracted configuration the handle is configured to be in the disengaged state; the user guidance comprises one of pushing or pulling the handle; the robotic system comprises a floor cleaning robot; the control of the navigation of the robotic system comprises the receipt of the user input to begin autonomous operation of the robotic system.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a,” “an,” and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a main robot in accordance with some embodiments of this disclosure.

FIG. 1B is a functional block diagram of a controller or processor in accordance with some embodiments of this disclosure.

FIG. 2A illustrates a robot comprising a user-controlled input in an engaged state, according to an exemplary embodiment.

FIG. 2B illustrates a robot comprising a user-controlled input in a disengaged state, according to an exemplary embodiment.

FIG. 3 is a process flow diagram illustrating a decision tree for engaging or disengaging brakes of a robot, according to an exemplary embodiment.

FIG. 4 is a functional block diagram illustrating a system configured to engage or disengage brakes of a robot, according to an exemplary embodiment.

FIG. 5 is a truth table illustrating decisions to engage or disengage brakes of a robot based on a state of the robot and user-controlled input, according to an exemplary embodiment.

FIGS. 6A-B illustrate two user-controlled input devices for controlling movement of a robot by a user, according to exemplary embodiments.

All Figures disclosed herein are © Copyright 2020 Brain Corporation. All rights reserved.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for configuring brakes on a robotic device. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, scooters, self-balancing vehicles such as manufactured by Segway, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, a user-controlled input device being in an engaged state corresponds to the user-controlled input being capable of manipulation by a user or operator (e.g., a human) to control a robot. Conversely, the user-controlled input device being in a disengaged state corresponds to the user-controlled device being in a state in which user inputs are either (i) not able to be received or communicated to the robot controller, or (ii) are ignored. Examples of various user-controlled inputs and their respective engaged or disengaged states are described in more detail below.

As used herein, a brake or braking system may refer to any (electro)mechanical system configured to, when engaged, prevent motion of wheels, treads, or other means of locomotion of a device, robot, or vehicle. A brake being disengaged, as used herein, may refer to the wheels, treads, or other means of locomotion being free to move unprohibited. By way of analogy, engaging a brake is equivalent to pressing downwards on a brake pedal in a car to prohibit its motion and disengaging the brake is equivalent to placing the car in neutral with no pressure on the brake pedal. Brakes may be implemented using brake pads (i.e., systems which use friction to prevent motion), magnetic brakes, and/or any other systems configured to inhibit motion of a device known within the art.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or 00B, cable modem, etc.), Wi-Fi (802.11), WiMAX (e.g., WiMAX (802.16)), PAN (e.g., PAN/802.15), cellular (e.g., 3G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors (e.g., neuromorphic processors), and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) enable robots to configure their braking systems to allow for rapid switching between autonomous and user-guided control; (ii) ensure robots remain safe on sloped surfaces in an event of a loss of power; and (iii) reduce time spent by operators to engage braking systems when swapping between autonomous and manual operation. Other advantages are readily discernible by one having ordinary skill in the art given the contents of the present disclosure.

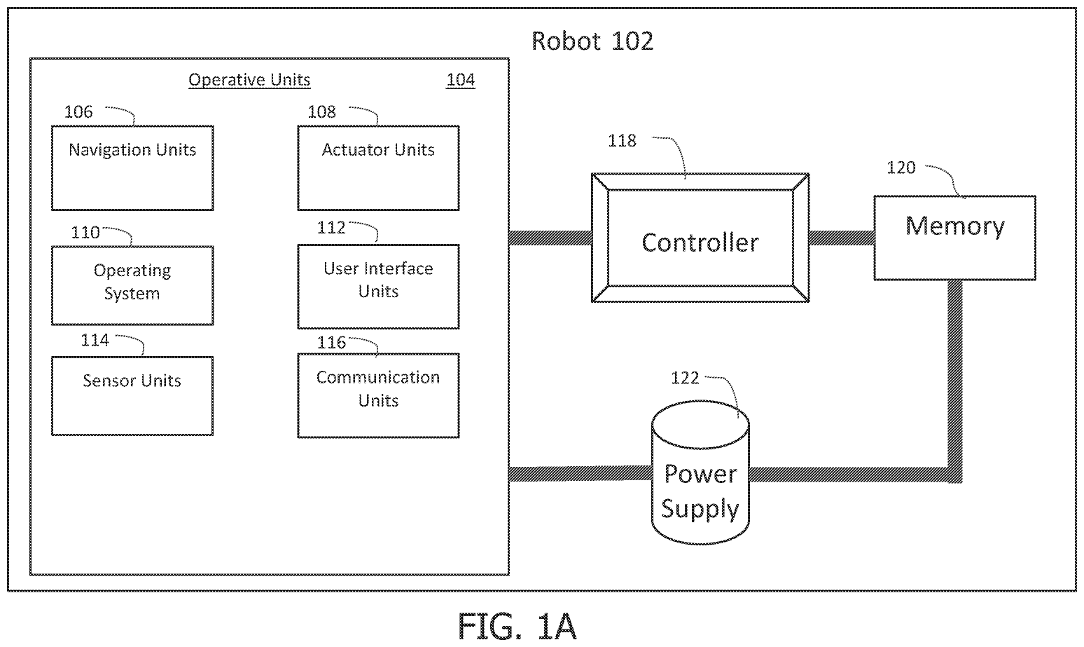

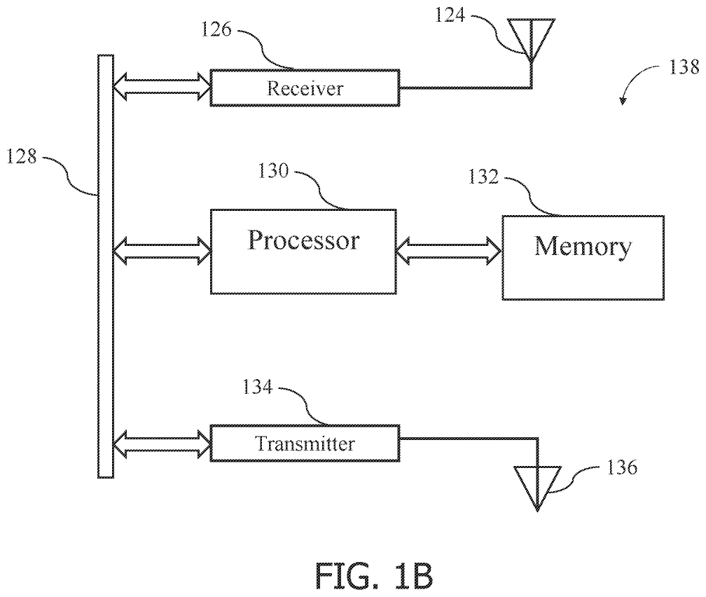

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors (e.g., microprocessors) and other peripherals. As previously mentioned and used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors, and application-specific integrated circuits (“ASICs”). Such digital processors may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be internal to or on board robot 102 and/or may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors. In some embodiments, a single controller (e.g., controller 118) may serve as the various controllers and/or processors described. In other embodiments different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units that provide the various functionality of robot 102. In exemplary embodiments, operative units 104 may be instantiated in software, hardware, or both software and hardware. For example, in some cases, units of operative units 104 may comprise computer-implemented instructions executed by a controller. In exemplary embodiments, units of operative units 104 may comprise hardcoded logic. In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; rotate cameras and sensors.

Actuator unit 108 may include any system used for actuating, in some cases to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art. According to exemplary embodiments, actuator unit 108 may include systems that allow movement of robot 102, such as motorized propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location. Notably, actuator unit 108 may include any system used for actuating, engaging or disengaging a braking system to stop and/or prevent movement of the robot 102.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“TOF”) cameras, structured light cameras, antennas, microelectromechanical systems (“MEMS”), nanoelectromechanical systems (“NEMS”), motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102′s position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wireless (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processor, or robot performing a task illustrated in the figures below comprises of controller-executing, computer-readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise of signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage media may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

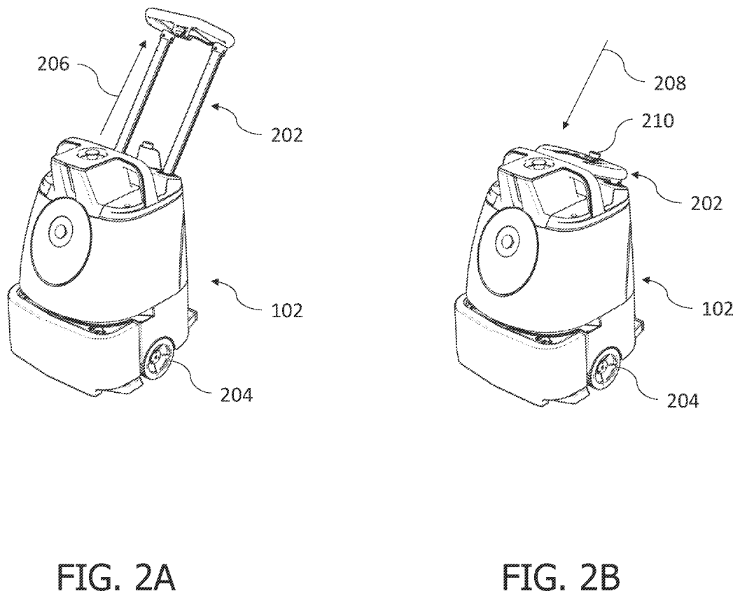

One of ordinary skill in the art would appreciate that the architecture illustrated in FIG. 1B may illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices, when instantiated in hardware, are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processing devices 138 thereof executing computer readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high-level tasks (e.g., planning a route to avoid obstacles) and processing devices 138 for performing low-level tasks (e.g., producing actuator signals in accordance with the route).

A feature disclosed herein is a robot comprising a user-controlled input that can be conveniently engaged or disengaged by a user to switch a robot between user-controlled input and autonomous operation. Preferably, the user-controlled input is at a position comfortable for human use when engaged and optionally in a stowed position when not engaged.

FIGS. 2A-B illustrate two positions for a user-controlled input comprising a handle 202 of a robot 102, according to an exemplary embodiment. First, in FIG. 2A, a robot 102 may be configurable to learn a route by an operator providing a pushing or pulling input to handle 202 to cause the robot 102 to move through the route while a controller 118 of the robot 102 collects and stores in memory 120 data from one or more sensor units 114. The data from the one or more sensor units 114 may be utilized to, in part, generate a computer readable map of an environment surrounding or comprising of the route. The computer-readable map may be later used by the controller 118 to reproduce the route and plan its trajectory around detected obstacles. The operator may extend, telescope or deploy the handle 202 to engage the learning process or engage manual operation of the robot 102 (e.g., to move the robot 102 if it becomes stuck). The handle 202 may extend to a length above a floor comfortable for human use; the extension being shown by vector 206 in FIG. 2A. As used herein, engagement of the handle 202 comprises of the extension of the handle 202 following vector 206 above a threshold amount (e.g., extended by 1 cm, 50 cm, or the entire length of handle 202), such that the robot 102 is operable under user control. Similarly, disengagement of the handle 202 corresponds to retracting the handle 202 following vector 208 as shown in FIG. 2B.

Next, in FIG. 2B, the robot 102 comprises of a lowered or stowed handle 202. The handle 202 may be lowered to engage autonomous operation of the robot 102 or to disable and store the robot 102 for future use. That is, the handle 202 may be lowered or disengaged any time an operator of the robot 102 no longer desires to manually control the movements of the robot 102. Lowering of the handle 202 is illustrated by vector 208. As used herein, disengagement of the handle 202 comprises of the retraction of the handle 202 following vector 208 below a threshold amount (e.g., the handle being retracted to 1 cm (centimeter), 50 cm, etc., from its lowest position) such that the robot 102 is not under user-guided control. A switch such as a button, toggle, or dial 210 may be disposed on the handle 202 or other portion of the robot 102 body, the button 210 may configure the controller 118 to resume or begin autonomous operation, which is different from the learning process or being engaged in a manual operation.

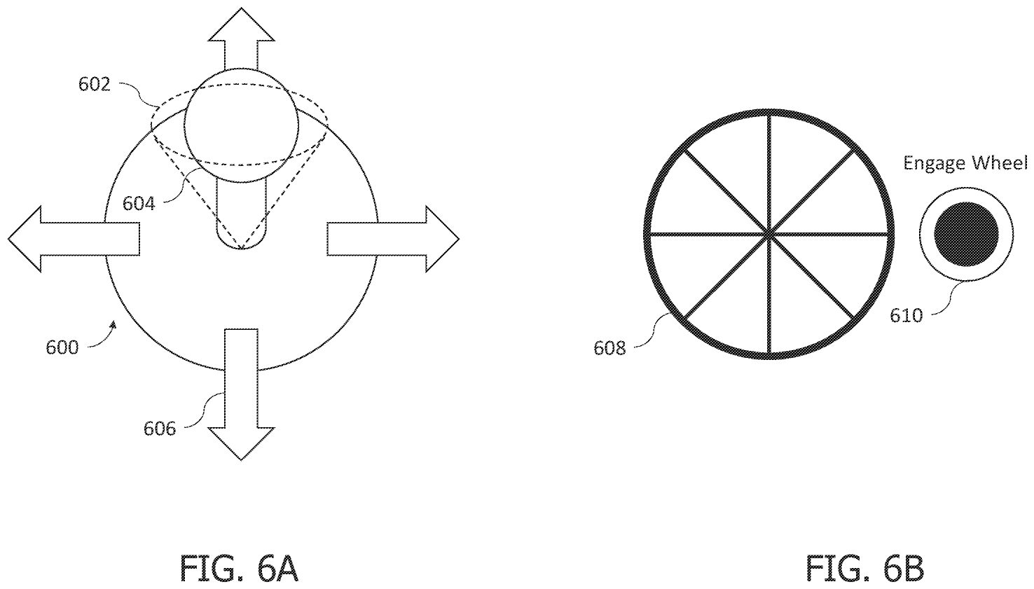

The embodiment shown in FIGS. 2A and 2B is illustrative of one embodiment of an engageable/disengageable handle and is not limiting. As shown in FIGS. 2A and 2B, the embodiment comprises of a handle with two extension rods supporting a handle comprising a user interface unit 112. Other embodiments comprise of a single extension rod supporting the user input panel handle. Other exemplary embodiments include those wherein the user input handle is engaged by unfolding an extension from the body of the robot 102, or those wherein the user input handle is engaged by rotating an extension from the body of the robot 102. In such embodiments, engagement/disengagement of the user-controlled input may comprise of an angle between the handle 202 and the body of the robot 102 or an angle between two portions of the handle 202 reaching a defined threshold angle (e.g. 10 degrees, 45 degrees, 90 degrees or 180 degrees, or any angle defined by the handle 202 in its fully deployed position). Additional exemplary embodiments illustrating user-controlled input devices being in an engaged or disengaged state are shown in FIG. 6A-B and discussed below.

In some embodiments, the switch 210 may be associated with a locking/unlocking device that a user operates to facilitate deployment (engagement) or stowage (disengagement) of the handle 202, either manually or by activating an actuator to deploy or stow the handle.

In some embodiments, the robot 102 may be configured, such as by size and/or shape that a position on the body of the robot 102 is always at a location comfortable for human use. In such embodiments, there is no need to deploy a handle for user control. In such embodiments, the user control panel may comprise of a switch 210 to engage/disengage user control. The switch may be configured as a toggle so that rotating a handle 202 forward engages user control and rotating the handle backward disengages user control.

In any of the embodiments, the switch 210 may comprise of a mechanical device or sensor that engages user control when a user's hand(s) are in contact with a locus on the handle (e.g., a pressure sensor, switch, etc.) and disengages user control when the user's hand(s) are not in contact with the locus on the handle.

In some embodiments, the handle 202 may be replaced with a wireless controller, such as a remote, game-pad, mouse and keyboard, or other means of controlling the robot 102 from a remote distance. In these embodiments, engagement of the user-controlled input corresponds to configuring the robot 102 under manual control with the wireless controller and disengagement of the user-controlled input corresponds to the wireless controller no longer being utilized to control motions of the robot 102.

According to at least one non-limiting exemplary embodiment, the robot 102 may comprise of a floor cleaning robot, such as a floor scrubber, vacuum, floor polishing, or other floor care robot configured to navigate upon a floor. The user input provided by an engaged handle 202 may allow the user to move the robot 102 over areas the user desires to be cleaned. Handle 202 may further comprise of a user interface unit 112 configurable to enable or disable a cleaning system (e.g., a vacuum) under manual control by the operator at certain times. In some instances, such as during training of a route, the controller 118 of the robot 102 may store when and where the cleaning system was enabled and disabled, and subsequently enable or disable the cleaning system at the same locations during autonomous operation.

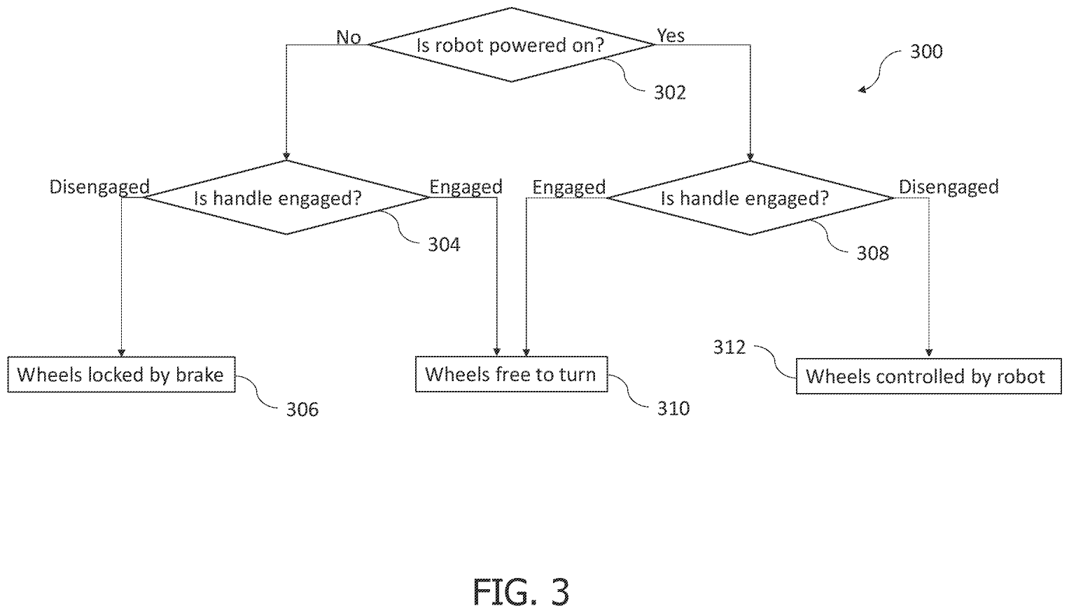

Controller 118 of the robot 102 may be configurable to determine when brakes for wheels 204 are to be engaged. The robot 102 may comprise of three operative modes: (i) an idle or powered off mode, (ii) a learning mode, and (iii) an autonomous mode. For each mode, the state of the handle 202 for use by an operator may influence the engagement or disengagement of brakes for wheel 204. A method 300 depicted next in FIG. 3 may be utilized by the controller 118 to determine if brakes are to be engaged or disengaged. As used herein, engaging brakes for wheels 204 of a robot 102 comprises activating a braking mechanism to impede rotation of the wheels 204, and vice versa for disengaging the brakes.

Although the present disclosure often refers to braking systems, which engage with wheels 204 of a wheeled robot 102, other locomotion means are considered without limitation such as caterpillar treads. Some embodiments of robot 102 may operate by moving along a cable or fixed track. One skilled in the art may readily appreciate the applicability of the inventive concepts of this disclosure to any locomotion means and braking system.

According to at least one non-limiting exemplary embodiment, the learning mode may allow the robot 102 to learn a route by being shown or moved along the route, wherein sensor and odometry data may be stored and later recalled for reproduction of the route. According to at least one non-limiting exemplary embodiment, the learning mode may comprise the robot 102 to receive communication, via communication units 116. The communication may comprise of route data, such as a computer-readable map of an environment of the robot 102, which may be utilized for later reproduction of the route.

FIG. 3 is a process flow diagram illustrating a decision tree 300 for enabling or disabling brakes on a robot 102 based on a state of a user-controlled handle 202, shown in FIGS. 2A-B, and state of the robot 102, according to an exemplary embodiment. A braking system of the robot 102 performing any steps or decisions discussed herein may be effectuated by, at least in part, the controller 118 of the robot 102 executing computer-readable instructions from a non-transitory computer-readable memory, such as memory 120, as appreciated by one skilled in the art. In some instances, as will be discussed below, the one or more steps may be effectuated using mechanical means. Stated differently, the braking system, as discussed herein, may include computerized portions (i.e., controller 118) and mechanical portions. Although the following discussion of the decision tree 300 includes a user-controlled input comprising of a handle (e.g., 202), one skilled in the art may appreciate that any user-controlled input of this disclosure, or equivalents thereof, may be utilized instead of a handle.

First, in block 302, the controller 118 of the braking system checks if the robot 102 is powered on. If the robot 102 is not powered on, or is powered down, the system moves to block 304. If the robot 102 is receiving power, the system moves to block 306. Powering on the robot 102 may include the controller 118 receiving any or at least a threshold amount of power from a power supply 122. Powering off the robot 102 may occur when a battery or power supply 122 outputs a power below a threshold value. Powering off may similarly occur when an operator turns off the robot 102 for use at a later time. In some instances, powering off may include a charging state of the robot 102 wherein the power supply 122 is being recharged from an external power supply (e.g., a wall outlet or specialized charging station).

Block 304 comprises the system to check if the handle is engaged (e.g., up, as shown in FIG. 2A) or disengaged (e.g., down, as shown in FIG. 2B). As shown in FIGS. 2A-B, the handle may be raised to enable manual control of the robot 102 (engaged) or lowered (disengaged) to either pause operations of the robot 102 or resume autonomous operation. The position of the handle 202 may be detected using one or more sensors 114, such as an encoder or switch, for example. Raising of the handle 202 may correspond to the handle 202 being in an engaged state and lowering of the handle 202 may correspond to the handle 202 being in a disengaged state.

Upon the controller 118 determining that the robot 102 is powered off and the handle is down (i.e., disengaged), the controller 118 engages the brake to lock the wheels 204 in place.

Upon the controller 118 determining that the robot 102 is powered off and handle is up (i.e., engaged), the controller 118 moves to block 310 wherein the brakes may be disengaged and/or the drive mechanism is switched to a neutral state, allowing the wheels to freely turn. This may correspond to a human operator moving the robot 102 to a location via pushing or pulling handle 202 prior to powering on or initializing the robot 102 at the location to perform a task.

According to at least one non-limiting exemplary embodiment, the engagement or disengagement of the brake when the controller 118 is not receiving power may be effectuated by mechanical means. For example, the brake may be mechanically coupled to the handle 202 such that, upon lowering of the handle, the brakes are engaged. The engagement of the brakes may be overridden by the controller 118 providing a signal to release the brakes, such as when the robot 102 operates autonomously as will be discussed next, wherein the signal may only be provided if power is supplied to the robot 102. In lieu of the overriding signal, the brakes may be engaged if the handle 202 is down and released when the handle 202 is up via mechanical coupling of the handle 202 to the brakes.

Returning to block 302, upon the controller 118 receiving power from a power supply, the controller 118 may move to block 308. Block 308 comprises the controller 118 to determine if the handle 202 is up or down (i.e., engaged or disengaged, respectively). The controller 118 may receive data from one or more sensor units 114 to detect the state of the handle 202.

Upon the controller 118 receiving power and detecting the handle 202 in the up or engaged state, the controller 118 may disengage the brakes in block 310 and placing the drive mechanism in neutral allowing the wheels 204 to freely turn. This may correspond to (i) an operator pausing autonomous operation of the robot 102 to move the robot 102 to a different location, (ii) an operator moving the robot 102 to a location to begin operation, or (iii) teaching a route to the robot 102 via pushing or pulling the handle 202 to cause the robot 102 to navigate the route under operator control.

According to at least one non-limiting exemplary embodiment, the detection of the user-controlled input device (e.g., handle 202 or other devices depicted in FIG. 6A-B) being in the engaged state while the robot 102 is receiving power may enable a human operator to operate the brakes and or drive system of the robot 102. For example, the robot 102 may be moved by the operator via the operator actuating acceleration and/or brake controls such as joysticks, toggles, brake levers, twist handles, pedals or the like, or using a remote controller.

Upon the controller 118 receiving power and detecting the handle is in the down or disengaged state, the controller 118 may operate brakes and actuator units 108 to effectuate autonomous navigation of the robot 102 in block 312. Brakes may be engaged or disengaged one or a plurality of times during autonomous operation to configure the robot 102 to avoid objects, turn, or otherwise operate autonomously.

According to at least one non-limiting exemplary embodiment, the controller 118 may await receipt of a user input prior to engaging autonomous operation in block 312. The user input may comprise of an input to a user interface unit 112, such as switch 210 depicted in FIG. 2B. The user input may provide confirmation to the operator that, upon lowering the handle, the robot 102 is to begin or resume its autonomous operation. The conformation may provide an additional safety verification step for the operator prior to autonomous operation of the robot.

Advantageously, the decision tree 300 provides for improved safety of robots 102 during autonomous operation. In some instances, robots 102 may be operating autonomously, with the handle 202 down, while on sloped surfaces and subsequently lose power (e.g., a battery dies). The decision tree 300 would engage the brakes of the robot 102 without the need for the operator to provide input. The decision tree 300 may enable this safety feature while not affecting normal operations of the robot 102, such as teaching routes or operating autonomously. Further, the operator may later move the robot 102 to a charging station via engaging the handle 202, which subsequently disengages the brakes, and pushing or pulling the robot 102 to the charging station.

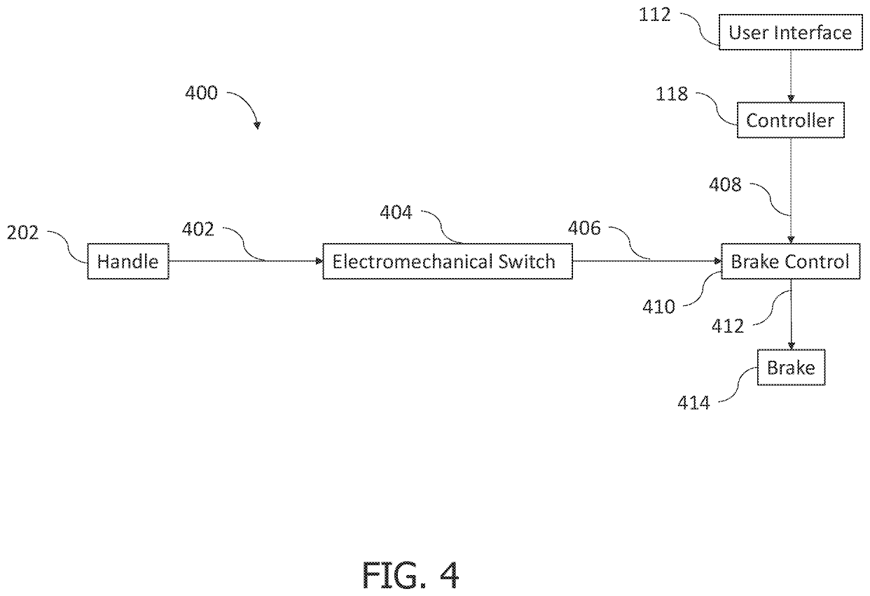

FIG. 4 is a functional block diagram of a braking system 400 configurable to engage or disengage a brake 414, according to an exemplary embodiment. The handle 202 may be in one of two states: engaged (e.g. up), or disengaged (e.g. down), as shown in FIG. 2A-B above. The state of the handle may be coupled to an electromechanical switch 404. The electromechanical switch may receive state data 402 of the handle 202; the state data comprising of the handle 202 being in an up or down state. The electromechanical switch 404 may be a mechanical switch or relay configurable to change state from engaged to disengaged based on the physical position of the handle 202. In some embodiments, a threshold may be imposed on the handle 202 state such that, upon lowering the handle beyond a specified value shown in FIG. 2B, the state of the handle 202 may be in the down (i.e., disengaged) state, or vice versa, and the electromechanical switch 404 may provide an electrical output 406 corresponding to the state of the handle 202 (e.g., a binary output or voltage at a specified level). The electromechanical switch may determine an engaged state of the handle when two electrical contacts are in contact when the handle is in the engaged state, thereby completing a circuit. The electromechanical switch may determine a disengaged state of the handle when two electrical contacts are not in contact when the handle is in the disengaged state, resulting in an open circuit.

The electrical output 406 may be provided to a brake control unit 410; the brake control unit 410 being configurable to provide a signal 412 to either engage or disengage a wheel brake 414. If output 406 indicates the handle 202 is in a down state, the brake control unit 410 will engage the brake 414, absent a signal 408 from a controller 118 as discussed below. Similarly, if the output 406 indicates the handle 202 is in the up state, the brake control unit 410 may disengage the brake 414. Brake 414 may comprise of any conventional braking system known within the art, without limitation, such as brake pads, hydraulics, and/or electromagnetic braking.

The brake control unit 410 may be further configurable to receive an output 408 from a controller 118 of the robot 102. The output 408 may comprise of a signal from the controller 118 to engage or disengage the brake 414. When the robot 102 is powered off or idle in a low-powered mode (i.e., not in use for training nor autonomous navigation, such as a “standby” mode), signal 408 may be absent or of a zero value. Accordingly, the engagement or disengagement of the wheel brake 414 is determined by signal 406 (i.e., state of handle 202) while the robot 102 is powered off. That is, the handle 202 being engaged configures the brakes to be disengaged, and vice versa following decision tree 300. When the robot 102 is receiving power, the signal 408 may be present and/or of non-zero value. Controller 118 may receive input from a user interface 112, the input comprising an operator engaging autonomous operation of the robot 102 (e.g., pressing a switch 210 depicted in FIG. 2B). Upon the controller 118 receiving the user input to engage autonomous operation, if signal 406 indicates the handle 202 is in a down or disengaged state, the controller 118 may provide output signal 408, which configures the brake controller 410 to be controlled by the controller 118. The controller 118 may subsequently navigate a route autonomously and may engage or disengage brake 414 to avoid obstacles and follow the route. If the signal 406 indicates the handle is engaged (e.g., in an up state) the brakes 414 are released allowing for user-controlled movement of the robot 102, regardless of the switch 210 being actuated or not.

In some instances, an operator may desire to engage the handle 202 while the robot 102 is operating autonomously. For example, the robot 102 may become stuck or unable to find a collision-free path during autonomous operation, wherein the operator may engage the handle 202 and move the robot 102 to a different location. As another example, the operator may desire the robot 102 to simply halt autonomous operation for any reason and may engage the handle 202 at any time. Accordingly, if at any time controller 118 is receiving power and output 406 indicates the handle 202 is in an engaged or up state, the brake controller 410 releases the brake 414.

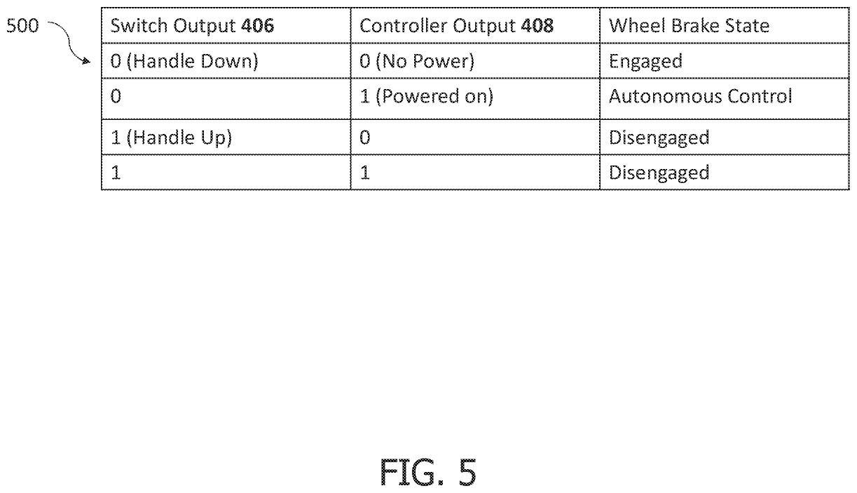

According to at least one non-limiting exemplary embodiment, electromechanical switch 404 may comprise of additional inputs capable of receiving output 408 from a controller 118. The electromechanical switch may determine if the robot 102 is receiving power based on output 408 and provide a corresponding output 406 to engage or disengage the wheel brakes following tree 300 of FIG. 3 or table 500 depicted in FIG. 5 below. In some instances, it may be advantageous to configure the braking control 410 and wheel brakes 414 to comprise of a purely mechanical system to ensure the wheel brakes 414 are engaged when power is lost. That is, brake control 410 being an electrical component configured to receive electrical signals 406, 408 is not intended to be limiting, and is illustrative of broader inventive concepts of this disclosure using one exemplary embodiment.

One skilled in the art may appreciate that the handle 202 depicted in FIG. 4 may be replaced with any user-controlled input device of this disclosure (e.g., as shown in FIG. 6A-B) or equivalents thereof.

FIG. 5 is a truth table 500 illustrating decision tree 300 and the various signals of system 400, according to an exemplary embodiment. Switch output 406 may comprise of a binary output corresponding to the state of a user-controlled input, such as handle 202. An output 406 of one (1) may correspond to the handle 202 being engaged under user control (e.g., in an up-state depicted in FIG. 2A) and an output 406 of zero (0) may correspond to the handle 202 being disengaged and not under user control (e.g., in a down-state depicted in FIG. 2B). Controller output 408 of one (1) may correspond to the controller 118 receiving power and an output 408 of zero (0) may correspond to the controller 118 not receiving power or low power, such as in a standby mode.

Both the outputs 406, 408 being zero (0) correspond to the handle 202 being disengaged (i.e., down) and the controller 118 receiving no or low power. In accordance with decision tree 300, the brake state is engaged and wheels 204 of the robot 102 are held in place. This may correspond to the robot 102 being stored (i.e., not utilized) for later use. In some instances, this may correspond to the robot 102 losing power while operating autonomously, wherein engagement of the brake is advantageous in that the robot 102 is safely stopped when power is lost (e.g., the robot 102 may lose power while on a sloped surface).

If output 406 is zero (0) and output 408 is one (1), the robot 102 is receiving power and the handle 202 is in a disengaged state. Accordingly, the engagement or disengagement of the brakes is/are based on outputs from the controller 118, which configure the robot 102 to navigate a route and/or may be further based on signals communicated from the controller 118 to actuator units 108. That is, the brakes and actuator units 108 may be engaged or disengaged in part or in whole to effectuate the navigation of the robot 102, wherein the controller 118 may activate or deactivate the brakes to control the speed of the robot 102 as it navigates.

If output 406 is one (1) and output 408 is zero (0), the robot 102 is not receiving power, but handle 202 is engaged by a user. This instance may correspond to the user desiring to move the robot 102 to a different location without operating the robot 102 or powering it on. Accordingly, the brakes are disengaged to allow for easy and unimpaired movement of the robot 102 (e.g., by pushing or pulling handle 202, using a joystick 600 or steering wheel 608, etc.). Further, controller 118 does not output signals to some or all of actuator units 108 to allow the robot 102 to be moved under user guided control (i.e. in a neutral state).

Lastly, if outputs 406 and 408 are both one (1), the robot 102 is receiving power and under user-guided control, and the user is moving the robot 102 by, for example, pushing or pulling handle 202. This instance may correspond to: (i) a user teaching a route for the robot 102 to follow by pushing or pulling the robot 102 through the route via handle 202, or (ii) the user pausing autonomous operation for any reason (e.g., robot 102 is stuck, stopping operation, etc.). Accordingly, the brakes are disengaged and in some instances, the drive mechanism is also disengaged (i.e. in a neutral state). In some embodiments, when outputs 406 and 408 are both one (1), the robot 102 is receiving power and under user-guided control, and the brakes and/or drive mechanism may be engaged by the user to facilitate movement of the robot 102.

Advantageously, the switch output 406 and controller output 408 both being zero may cause engagement of the brakes 414 if power is lost, for example, due to a battery or power supply 122 providing insufficient power. This may enhance safety of robots 102 operating on sloped surfaces. Failure to engage brakes on a sloped surface after losing power may cause the robot 102 to roll or move uncontrolled and potentially cause damage to nearby objects, the robot 102 itself, or humans. The brakes may then be disengaged only when an operator engages the handle 202 to move the robot 102, even when the robot 102 is not being powered, thereby allowing the operator to move the robot 102 at any time they desire.

According to at least one non-limiting exemplary embodiment, handle 202 may be replaced with other user-controlled input devices, as further shown and described below in FIG. 6A-B. The one or more user-controlled input devices comprising at least an engaged state and a disengaged state, the engaged state enables user control of movement of the robotic device. The user-controlled input device being in a disengaged state may configure the robotic device to either, based on receiving or not receiving power from power supply 122, (i) enable controller 118 to configure the brake 414 to navigate the robotic device, or (ii) engage brake 414 and halt movement, respectively.

Although the above disclosure has been primarily with reference to a handle 202 of FIGS. 2A-B, other methods for providing user-controlled inputs configured to move a robot 102 are considered. For example, as shown in FIG. 6A, a joystick 600 may be disposed on the robot 102 to enable a human operator to provide manual control of the robot 102, according to an exemplary embodiment. The joystick 600 may be moved in any of directions 606 to enable a robot 102 to move along two degrees of freedom, such as upon a floor. Engagement of the joystick 600 may comprise of movement of the joystick handle 604 beyond an angular threshold 602. Similarly, disengagement of the joystick 600 may include any movement, or lack thereof, of the joystick handle 604 within angular threshold 602. Threshold 602 may be utilized to ensure perturbations to the joystick handle 604 due to, for example, the robot 102 navigating over bumpy floors, which does not cause engagement of the joystick 600 for controlling the movement of the robot 102. In some embodiments, the joystick 600 may be configured to actuate power to the drive mechanism of the robot to facilitate its movement while under user control. In some embodiments, the extent of motion of the joystick 600 in any of the directions 606 may be operationally connected to the drive mechanism to control the speed of movement of the robot 102 while under user control.

FIG. 6B illustrates another exemplary user-controlled input comprising a steering wheel 608 and an engage wheel switch 610, according to an exemplary embodiment. Engage wheel switch 610 may enable the steering wheel 608 to be turned clockwise or counterclockwise, wherein the steering wheel 608 may remain locked in absence of the switch 610 being actuated as a safety feature. Turning of the wheel 608 may configure one or more wheels, treads, or other locomotion means of the robot 102 to correspondingly turn, thereby allowing an operator to control movement of the robot 102. Accordingly, engagement of the user-controlled input of wheel 608 may be effectuated based on the engage wheel switch 610, wherein the steering wheel 608 being unlocked or released corresponds to the user-controlled input being engaged, and vice versa (i.e., similar to handle 202 being extended). This embodiment may further include acceleration and/or brake pedals, switches, buttons, or levers disposed elsewhere on the robot 102 (not shown).

According to at least one non-limiting exemplary embodiment, engage wheel switch 610 may comprise a keyhole or user interface displaying a pin code. Use of a key and/or pin codes may further enhance safety by ensuring only known operators of the robot 102 may engage the wheel 608.

According to at least one non-limiting exemplary embodiment, joystick 600 of FIG. 6A may further comprise of an engage joystick button, keyhole, or pin code similar to the engage wheel switch 610 of FIG. 6B. Engagement of the joystick 600 in this embodiment may comprise of either or both of the engage joystick button, keyhole, or pin code being engaged (i.e., button pressed, key inserted into the keyhole, or pin code correctly inputted) or the joystick handle 604 being moved beyond a threshold 602.

According to at least one non-limiting exemplary embodiment, a user-controlled input device may comprise a throttle wheel or knob. The throttle knob may enable a user to configure a speed of the robot 102 while operating the robot 102 under user control, for example, in conjunction with a steering wheel 608. The throttle knob being at zero (0) may correspond to the user-controlled input device being disengaged and the throttle knob being at any value or a threshold value above zero may correspond to the engaged state.

According to at least one non-limiting exemplary embodiment, any of the embodiments of the user control input feature may further comprise one or more of an application on a cell phone, fob, identification card, dongle, remote controller, game-pad, or other device configurable to communicate with the controller 118 via RFID, LTE, NFC, or WiFi to authenticate that a human is an authorized or known operator of the robot 102. Use of an authentication device may further enhance safety by ensuring only known operators of the robot 102 may engage the user control input.

According to at least one non-limiting exemplary embodiment, the user-controlled inputs as shown and described above in FIGS. 2A-B and 6A-B may further include one or more key-holes, radio-frequency identification (RFID) readers, or other means for verifying that a user should control the motions of the robot 102. For example, in order to enable use of the steering wheel 608 and/or button 610, an operator must insert a key into a separate key-slot, wherein the key is only provided to operators of the robot 102. As another example, the handles 202 as shown in FIGS. 2A-B above may only be extendable/retractable if and only if a known RFID tag is sensed by an RFID reader of the robot 102, wherein the RFID tag may be embedded in an access card or similar device provided only to operators of the robot 102.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustrations and descriptions are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open-ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” or the abbreviation “e.g.” is used to provide exemplary instances of the item in discussion, not an exhaustive or limiting list thereof, and should be interpreted as “example, but without limitation;” the term “illustration” is used to provide illustrative instances of the item in discussion, not an exhaustive or limiting list thereof, and should be interpreted as “illustration, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A robotic system, comprising:
a user-controlled input comprising at least an engaged state and a disengaged state;
actuator units configured for locomotion of the robotic system, the actuator units being coupled to a brake, the brake configured to inhibit locomotion of the robotic system when engaged;
a power supply; and
at least one processing device configured to execute computer readable instructions stored on a memory to,
engage the brake upon the power supply outputting a power level below a threshold and the user-controlled input being in the disengaged state;
release the brake upon the user-controlled input being in the engaged state; and
control navigation of the robotic system along a route and avoid obstacles upon the user-controlled input being in the disengaged state and the power supply outputting above a threshold power level.

2. The robotic system of claim 1, wherein,
a respective state of the user-controlled input is detected in either the engaged state or the disengaged state based on output of an electromechanical switch.

3. The robotic system of claim 1, wherein,
the user-controlled input is configured to receive a user guidance to move the robotic system along a route.

4. The robotic system of claim 3, wherein,
the user-controlled input comprises a handle configured to be extended from the robotic system and retracted into the robotic system, wherein in the extended configuration the handle is configured to be engaged by a user, and in the retracted configuration the handle is configured to be in the disengaged state; and
the user guidance comprises one of pushing or pulling the handle.

5. The robotic system of claim 1, wherein,
the robotic system comprises a floor cleaning robot.

6. The robotic system of claim 1, further comprising:
a user interface configurable to receive a user input, the user input configured to autonomously operate the robotic system when the user-controlled input is in the disengaged state.

7. The robotic system of claim 6, wherein,
the control of the navigation of the robotic system further comprises receipt of the user input to begin autonomous operation of the robotic system.

8. The robotic system of claim 1, wherein,
the user-controlled input comprises one of a retractable handle, a joystick, a throttle knob, or a steering wheel.

9. A method, comprising:
engaging a brake upon a power supply of a robot outputting a power level below a threshold and a user-controlled input being in a disengaged state;
releasing the brake upon the user-controlled input being in an engaged state; and
controlling navigation of the robotic system along a route and avoid obstacles upon the user-controlled input being in the disengaged state and the power supply outputting above a threshold power level;
wherein,
in the engaged state, the robot configured to be operable by a human; and
engaging the brake inhibits locomotion of the robot.

10. The method of claim 9, wherein,
a respective state of the user-controlled input is detected in either the engaged state or disengaged state based on output of an electromechanical switch.

11. The method of claim 9, wherein,
the user-controlled input is configurable to receive a user guidance to move the robotic system along a route.

12. The method of claim 11, wherein,
the user-controlled input comprises a handle which may be extended from the robotic system and retracted into the robotic system, wherein in the extended configuration the handle is configured to be in the engaged state by the user, and in the retracted configuration the handle is configured to be in the disengaged state; and
the user guidance comprises one of pushing or pulling the handle.

13. The method of claim 9, wherein,
the robotic system comprises a floor cleaning robot.

14. The method of claim 9, further comprising:
a user interface configurable to, in part, receive a user input, the user input configures the robotic system to operate autonomously when the user-controlled input is disengaged.

15. The method of claim 14, wherein,
the control of the navigation of the robotic system further comprises receipt of the user input to begin autonomous operation of the robotic system.

16. The method of claim 9, wherein,
the user-controlled input comprises one of an extendable handle, a joystick, a throttle knob, or a steering wheel.

17. A robotic system, comprising:
a user-controlled input comprising at least an engaged state and a disengaged state;
actuator units configured for locomotion of the robotic system, the actuators being coupled to a brake, the brake inhibits the locomotion when engaged;
a power supply; and
at least one processing device configurable to execute computer readable instructions stored on a memory to,
engage a brake upon the power supply outputting a power level below a threshold and the user-controlled input being in the disengaged state;
release the brake upon the user-controlled input being in the engaged state;
control navigation of the robotic system along a route and avoid obstacles upon the user-controlled input being in the disengaged state and the power supply outputting above a threshold power level; and
receive a user input from a user interface configurable to, in part, the user input configures the robotic system to operate autonomously when the user-controlled input is disengaged;
wherein,
a respective state of the user-controlled input is detected in either the engaged state or disengaged state based on output of an electromechanical switch;
the user-controlled input is configurable to receive a user guidance to move the robotic system;
the user-controlled input comprises a handle configured to be extended from the robotic system and retracted into the robotic system, the extended configuration the handle is configured to be engaged by a user, and in the retracted configuration the handle is configured to be in the disengaged state;
the user guidance comprises one of pushing or pulling the handle;
the robotic system comprises a floor cleaning robot;
the control of the navigation of the robotic system comprises the receipt of the user input to begin autonomous operation of the robotic system.
